(19) United States
(12) Patent Application Publication
(10) Pub. No.: US 2014/0354782 A1
(43) Pub. Date: Dec. 4, 2014

(54) Stereoscopic Camera Apparatus

(71) Applicant: Ethan Lowry, Santa Barbara, CA (US)

(72) Inventor: Ethan Lowry, Santa Barbara, CA (US)

(21) Appl. No.: 14/289,647

(22) Filed: May 29, 2014

Related U.S. Application Data
(60) Provisional application No. 61/828,426, filed on May 29, 2013.

(51) Int. Cl. H04N 13/02

(52) U.S. Cl. CPC H04N 13/0235
USPC 348/49

(57) ABSTRACT

An apparatus for receiving an image sensor-enabled smartphone, enabling a user of the apparatus to capture and view three-dimensional images with a smartphone normally capable of only capturing and rendering two-dimensional images. The apparatus includes a first arrangement of optics, said first arrangement being aligned with an image sensing arrangement of a smartphone when the smartphone is inserted into the apparatus. The apparatus also includes a second arrangement of optics, said second arrangement of optics being aligned with a display portion of a smartphone when the smartphone is inserted into the apparatus. The first arrangement of optics enables capture and/or rendering of a stereoscopic visual data stream (3-D still images or 3-D full-motion video, among others). The second arrangement of optics enables a viewer to see a stereoscopic effect when any stereoscopic visual data stream accessible by the smartphone is rendered by the display of the smartphone aligned with the second arrangement.

### PRIORITY CLAIM

This invention claims the benefit of the U.S. provisional patent application entitled “Stereoscopic Camera Apparatus”, naming Ethan Lowry as the inventor, filed May 29, 2013 and having received application Ser. No. 61/828,426 (our ref. LOWR-1-1001). The foregoing application is incorporated by reference in its entirety as if fully set forth herein.

### FIELD OF THE INVENTION

This invention relates generally to an apparatus for viewing and recording stereoscopic images.

### SUMMARY

Modern day smartphones are designed to allow a user to capture and view two-dimensional images. An individual may use a smartphone to capture or view two-dimensional video media. The present invention allows a smartphone with camera and view screen capability to capture and view three-dimensional images using the smartphone camera lens and view screen respectively. The invention comprises of at least one set of optics, which may include mirrors and/or lenses, aligned with the smartphone camera to facilitate capture, and another pair of optics, which may include mirrors and/or lenses, aligned with the device view screen to facilitate viewing the three-dimensional images.

### BRIEF DESCRIPTION OF THE DRAWINGS

Embodiments of the present invention are described in detail below with the following drawings:

FIGS. 1a and 1b are isometric views of the apparatus in the closed position, in accordance with an embodiment of the invention;

FIG. 2 is an isometric view of the apparatus in the open position as used when capturing images and video, in accordance with an embodiment of the invention;

FIG. 3 is an isometric view of the apparatus in the open position with the cover removed such that the mirrors that align with the smartphone camera are visible, in accordance with an embodiment of the invention;

FIG. 4 is an isometric view of the apparatus in the closed position with the cover removed, in accordance with an embodiment of the invention;

FIG. 5 is a plan view of the apparatus in the closed position, as viewed from the user's perspective, in accordance with an embodiment of the invention;

FIG. 6 is a plain view of the apparatus in the open position, as viewed from the user's perspective, in accordance with an embodiment of the invention;

FIG. 7 is an isometric view of the apparatus such that the mirror assembly is separated from the viewing assembly, in accordance with an embodiment of the invention; and

FIG. 8 is an isometric view of the apparatus showing the apparatus in transition between the open and closed position, in accordance with an embodiment of the invention.

### DETAILED DESCRIPTION

This invention relates generally to three-dimensional video media, and specifically to viewing and capturing stereoscopic images through the use of a smartphone device. The present invention is an apparatus designed to view and capture stereoscopic images by inserting a smartphone with camera and view screen capability into the body of the apparatus, 1.

In its most basic embodiment, the apparatus comprises of eyepieces, 4, that facilitate stereoscopic viewing of the smartphone view screen and a system of mirrors positioned in front of the smartphone camera that presents a pair of stereoscopic images to be captured by the smartphone camera. In this embodiment, the apparatus does not consist of any electronic or moving parts.

The apparatus consists of two components, a mirror-box, 3, and view-box, 1, which capture and facilitate viewing of stereoscopic images respectively. These components may operate simultaneously in combination or independent of one another. In at least some embodiments, the stereoscopic image being captured via the mirror-box component is viewable on the view-box during the capture process, enabling an operator to view and refine a three-dimensional image as it is being captured and/or framed, necessitating both the mirror-box and view-box aspects of the present invention.

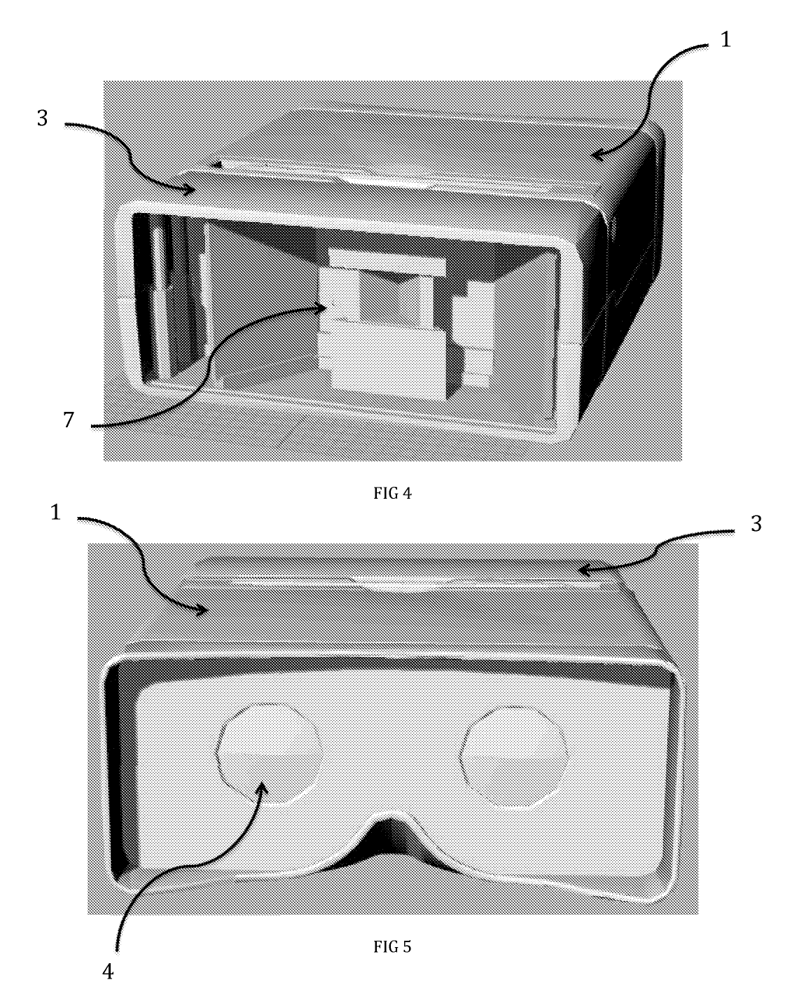

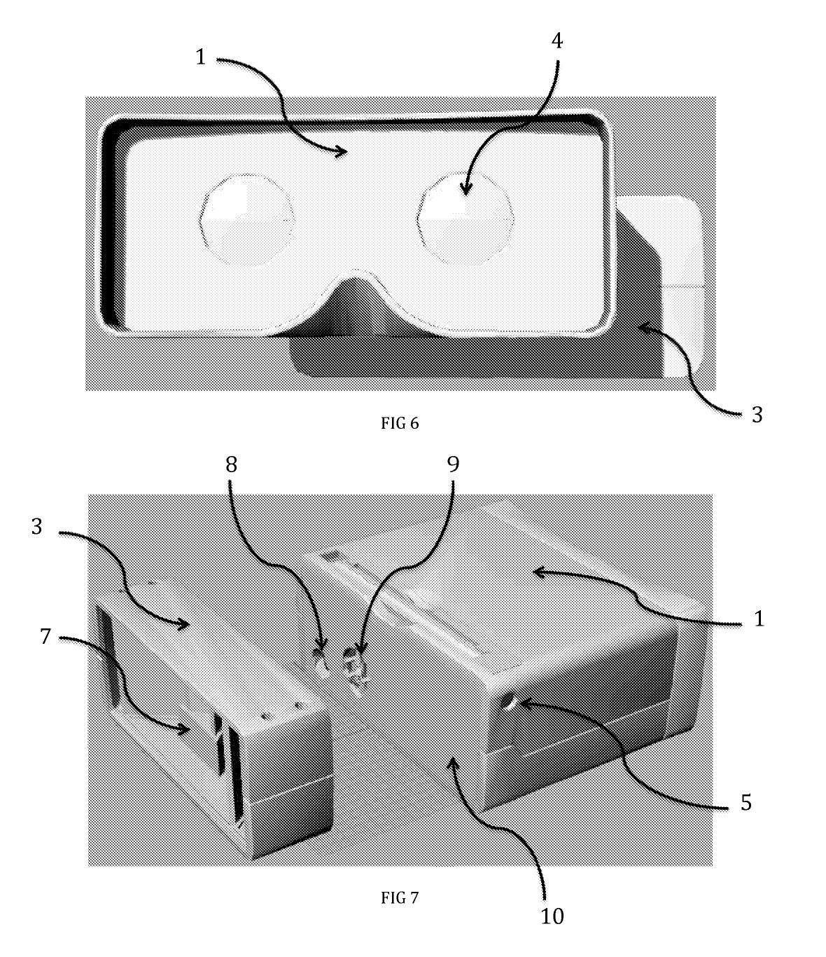

The camera-facing aspect of the apparatus, identified hereafter as “mirror-box,” comprises of two inner mirrors positioned directly in front of the camera lens, 7, and two outer mirrors, to capture a stereoscopic image. In some embodiments, the two outer mirrors may be positioned with varying spacing to capture the stereoscopic image. Spacing may be varied to achieve particular stereoscopic effects. For example, inter-pupillary spacing will result in a 3D effect substantially similar to normal human vision, whereby wider spacing may result in an exaggerated 3D effect for distant objects and narrower spacing may result in an exaggerated 3D effect for closer objects. FIGS. 3 and 4. Stereoscopic images are captured using the smartphone single lens. As a result, there is no requirement for a complex synchronization mechanism.

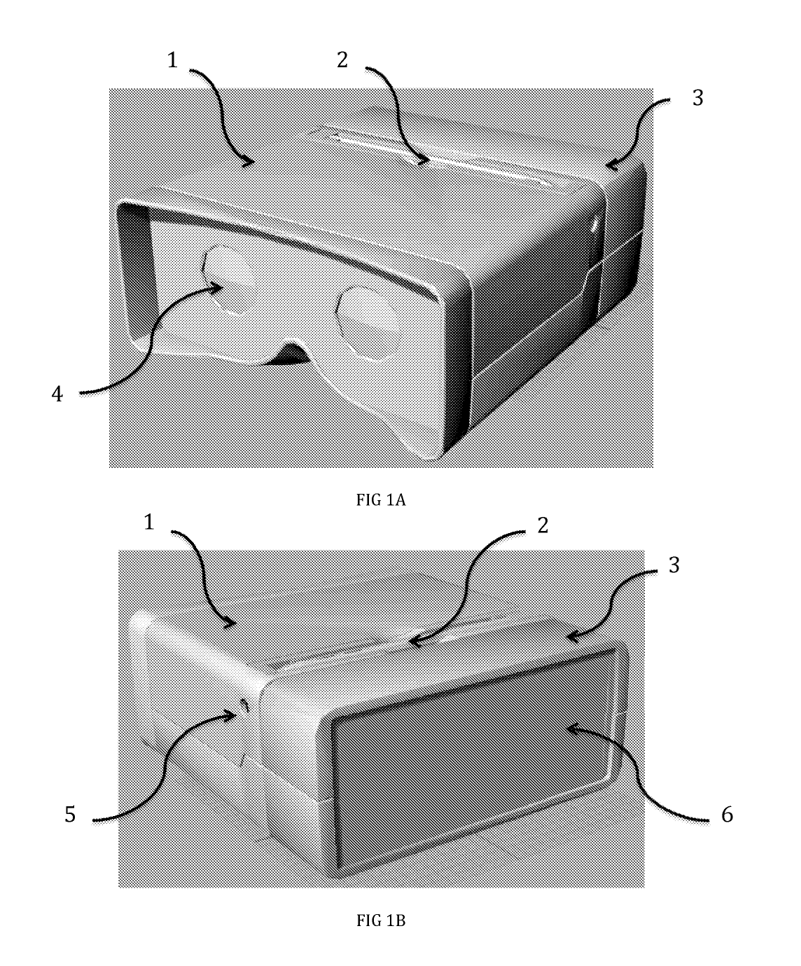

In its most basic embodiment, the view-facing aspect of the apparatus, identified hereafter as “view-box,” 1, comprises of two eyepieces lenses, 4. In some embodiments, a separator plate in conjunction with the view-box may be used to isolate the pair of stereo-separated images. FIG. 1a. In another embodiment, a separator plate may be adjustable to better accommodate a wide range of smartphone devices with different screen sizes and placements. In yet another embodiment of the view-box, the device may comprise of two prisms aligned with the center point of each half of the smartphone screen in order to optimize lens magnification and ease the viewer's ability to see the stereoscopic effect. In this embodiment, each prism would be positioned such that the viewer would simply draw his focus forward towards the prisms and through the prisms, view the images reflected from the center point of each half of the smartphone screen.

Additional possible features of the view-box component may include an Active Shutter system that is synchronized with the smartphone screen. An active shutter system would allow images viewed through the view-box component to be presented full screen instead of as half-size stereoscopic pairs.

Another possible feature of the view-box component includes magnified viewing and full screen display of a three-dimensional image using a smartphone device that natively supports three-dimensional viewing through a lenticular display.

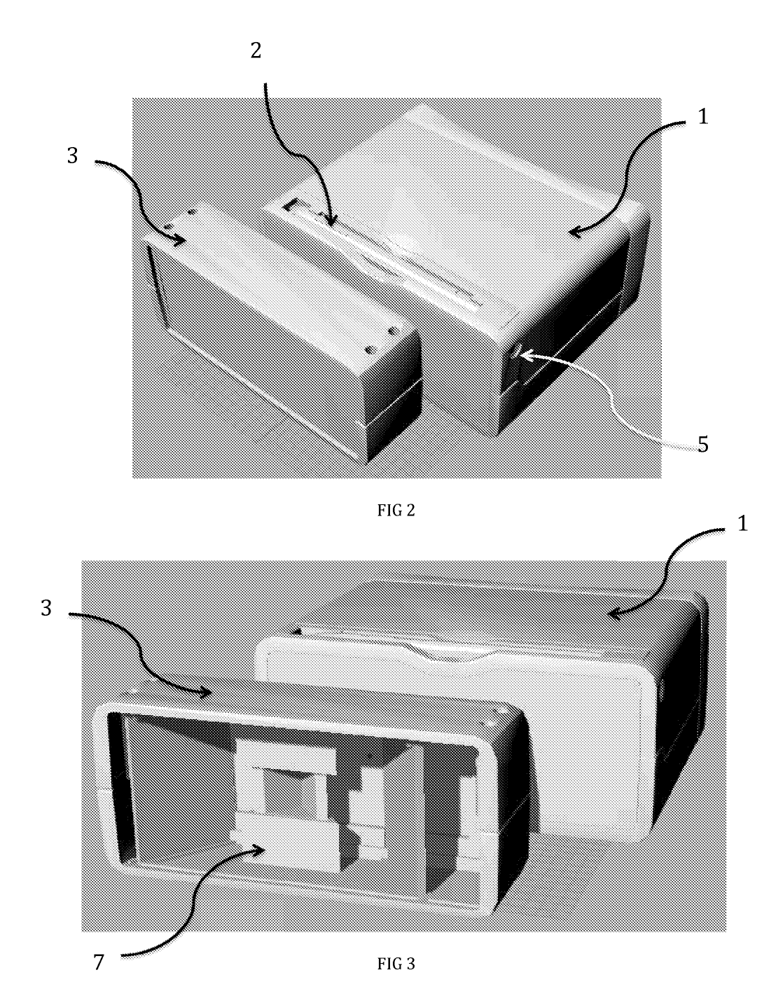

The body of the apparatus is designed to receive a wide range of smartphone devices of varying size and shape. In one embodiment, the device may be used with an iPhone brand smartphone. In another embodiment, the device may be used with other branded smartphones, such as but not limited to an Android smartphone. In one embodiment, the apparatus comprises of an oversized slot, 2, designed to receive a wide range of smartphone devices. The apparatus then functions through an interfacing insert that caters for variations in smartphone size and shape. The insert comes with the added advantage of ensuring that each smartphone camera is correctly aligned with the mirror-box component used to capture the stereoscopic images. In yet another embodiment, a small opening on the side of the apparatus, 5, is positioned to overlap a smartphone audio jack. FIG. 1B and FIG. 2. Access to the audio jack may allow a user to utilize the audio jack for a remote trigger/cable release.

In the present embodiment, the view-box component, 1, is designed to accommodate smartphones of different screen sizes through a repositionable divider plate. The divider plate is used to isolate the image viewed by each eye, and may be repositioned through a slotted mechanism incorporated in the view-box component.

Additional possible features of the apparatus may include a latching mechanism that would protect the mobile device from accidentally falling out of the apparatus.

Additional possible features of the apparatus may include physical buttons on the apparatus designed to enhance user experience by interacting directly with the smartphone interface.

Additional possible features of the apparatus may include adjusting the mirror position through a mechanical arrangement engaged by the user. The user may intend to move the mirrors to adjust an image zoom (independent of any optical or digital zoom provided by the smartphone itself) or simply to collapse the mirrors flat when the device is not in use.

Additional possible features may include a system of lenses and/or additional mirrors and prisms that are intended to reduce the overall physical size of the apparatus.

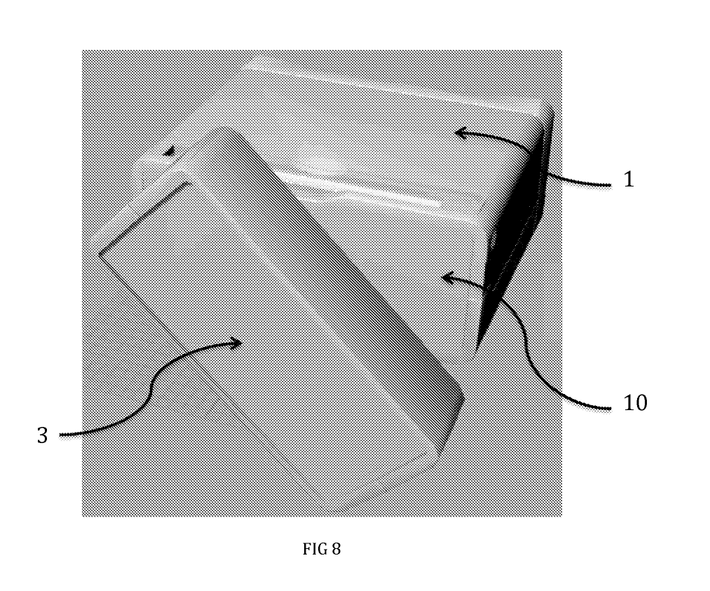

Additional possible features of the mirror-box component may include a pivot plate, 10, designed to accommodate different camera positions on multiple smartphone designs. Since the mirror assembly in the mirror-box component must be positioned over the smartphone camera lens, 8, a pivot plate assembly may be incorporated to position and or rotate the mirror assembly in place, 9. FIG. 7 and FIG. 8. The pivot plate is an interchangeable component that is specifically designed for particular smartphone camera positions. If the apparatus is to be used with multiple smartphones of which have multiple camera positions, each smartphone will require its own pivot plate. Since the pivot plate is designed to be an interchangeable component, the remainder of the apparatus is left intact and unchanged.

Additional possible features include a program of instructions readable by the apparatus, and executable by the apparatus, which perform method steps that optimize the presentation of stereoscopic images on the apparatus. In another embodiment, the program of instructions may allow changes to the camera field of view by repositioning statically positioned mirrors in the apparatus.

Additional possible features include a program of instructions readable by the apparatus, and executable by the apparatus, which perform method steps that provide an accessible interface of the smartphone functionality when the smartphone is inserted into the apparatus and is thus inaccessible. In another embodiment, the program of instructions may access smartphone GPS, compass or accelerometer functionality.

Additional possible features include a program of instructions readable by the apparatus, and executable by the apparatus, which performs method steps that allow a digital community to share, rate and discuss three-dimensional images and videos that are captured or viewed on the apparatus. In one embodiment, the program of instructions would allow users to access the digital community both on the apparatus, and independently of the apparatus through a server-based component. In another embodiment, the program of instructions would facilitate sharing of the three-dimensional images or video through a proprietary community, email, MMS, or any other service, such as Facebook or Twitter. In another embodiment, the program of instructions would also allow images and videos to be shared with non-three dimensional devices. In yet another embodiment, the program of instructions may enable third parties to create content and provide a marketplace for sharing and or purchasing content through the apparatus.

Additional possible features include a program of instructions readable by the apparatus, and executable by the apparatus, which would allow three-dimensional images and video to be stereoscopically viewed on the apparatus.

Additional possible features include a program of instructions readable by the apparatus, and executable by the apparatus, which would enhance features of an image viewed or captured on the device. An example of these enhancements includes increasing contrast and or saturation, and sepia tone filter effects.

Additional possible features include a program of instructions readable by the apparatus, and executable by the apparatus, which would enable games, virtual reality, augmented reality, or other novel three-dimensional applications to function on the apparatus.

What is claimed is:

1. An apparatus for viewing and recording stereoscopic images, comprising:
means for receiving a smartphone;
means for presenting at least one stereoscopic image within at least one field of view of at least one image sensor of the smartphone; and
means for rendering at least one stereoscopic image based at least partially on at least one image displayed by the smartphone.
